(19) United States
(12) Patent Application Publication
(10) Pub. No.: US 2006/0071539 A1
(43) Pub. Date: Apr. 6, 2006

(54) Clad wheel assembly

(75) Inventor: Paulo Celso de A. Sereno, Limeira (BR)

Correspondence Address: CARLSON, GASKEY & OLDS, P.C., 400 WEST MAPLE ROAD, SUITE 350, BIRMINGHAM, MI, 48009, US

(73) Assignee: ArvinMeritor do Brasil Sistemas Automotivos Ltda

(21) Appl. No.: 10/958,833

(22) Filed: Oct. 5, 2004

(51) Int. Cl. B60B 7/06

(52) U.S. Cl. 301/63.104

(57) ABSTRACT

A vehicle wheel assembly includes a wheel rim with an inner and outer circumferential surface and a pair of rim flanges extending outwardly from the outer circumferential surface at opposing rim edges. The inner circumferential surface defines an inner wheel cavity. A first wheel disc includes a vertical side surface and a transversely extending flange portion that is received within the inner wheel cavity. The transversely extending flange portion is directly welded to the inner circumferential surface of the wheel rim at a first attachment interface. A second wheel disc is overlaid on top of the vertical side surface and is welded directly to the first wheel disc at a second attachment interface that is independent from the first attachment interface.

### TECHNICAL FIELD

The subject invention relates to a vehicle wheel assembly having a first wheel disc attached to an inner surface of a rim and a second wheel disc attached to the first wheel disc to provide a robust wheel structure and a stylized appearance for the vehicle wheel assembly.

### BACKGROUND OF THE INVENTION

A vehicle wheel assembly typically includes an outer rim component and a wheel disc that is attached to the outer rim component. In addition to being a structural component, the wheel disc has an exterior face that provides the vehicle wheel assembly with a stylized appearance. The wheel disc is typically stamped to a desired configuration. The desired configuration typically includes a hub attachment portion surrounding a center opening and a plurality of ventilation openings for cooling an associated wheel brake assembly.

In order to effectively compete in today's market, it is important to be able to provide a variety of exterior faces for the vehicle wheel assembly. Differences in the number and shape of the ventilation openings, in addition to different surface profiles between the ventilation openings, can provide many different styling options. However, one disadvantage with providing different styling options is that different stampings are required for the wheel disc. This increases cost.

Also, in order to provide sufficient structural integrity, the wheel disc must have a certain thickness. Thicker material requires a greater pressing force during stamping operations, which also increases manufacturing costs.

Thus, it is desirable to have a vehicle wheel assembly that reduces manufacturing cost while providing a variety of stylized appearances.

### SUMMARY OF THE INVENTION

A vehicle wheel assembly is formed from at least three (3) components. A first component includes an outer circumferential surface and an inner circumferential surface that defines an inner wheel cavity. A second component includes a portion that is received within the inner wheel cavity and is attached to the inner circumferential surface at a first attachment interface. A third component is overlaid on top of the second component and is attached to the second component at a second attachment interface that is independent from the first attachment interface to form a final vehicle wheel assembly.

In one disclosed embodiment, the first component is a rim having a pair of rim flanges extending outwardly from opposing edges of the outer circumferential surface. The second component is a first wheel disc having a first vertical surface and a transversely extending flange formed about a perimeter of the first vertical surface. The transversely extending flange extends into the inner wheel cavity and is welded to the inner circumferential surface to form the first attachment interface. The third component is a second wheel disc that is overlaid on top of the first vertical surface to form an exterior face of the vehicle wheel assembly. The second wheel disc is preferably referred to as a clad type wheel disc that provides a stylized appearance for the exterior face of the vehicle wheel assembly. The second wheel disc is welded to the first wheel disc to form the second attachment interface.

In one example, the second wheel disc includes a center opening defined by a peripheral edge. The second wheel disc is welded to a center portion of the first wheel disc about the peripheral edge of the center opening. The welding can be formed as a continuous weld or a plurality of discrete welds.

In another example, the second wheel disc includes a plurality of ventilation openings formed circumferentially about the center opening. A peripheral edge of each of the plurality of ventilation openings is welded to the first wheel disc to form the second attachment interface.

The subject vehicle wheel assembly provides a robust wheel structure, which has greater flexibility for styling when compared to prior vehicle wheel assembly designs. These and other features of the present invention can be best understood from the following specification and drawings, the following of which is a brief description.

### BRIEF DESCRIPTION OF THE DRAWINGS

FIG. 1 is an exploded view of one example of a wheel assembly incorporating the subject invention.

FIG. 2 is a perspective view of a basic disc and rim from the wheel assembly of FIG. 1.

FIG. 3 is a perspective view of a clad disc on the wheel assembly of FIG. 2.

FIG. 4 is a perspective view of a cover on the wheel assembly of FIG. 3.

FIG. 5 is a view showing a first attachment interface between the basic disc and the rim of the wheel assembly of FIG. 1.

FIG. 6A is a magnified view of the first attachment interface partially broken away.

FIG. 6B is a view showing one example of a second attachment interface between the clad disc and the basic disc of the wheel assembly of FIG. 1.

FIG. 7 is an exploded view of another example of a wheel assembly incorporating the subject invention.

FIG. 8 is a perspective view of a clad disc overlaid on a basic disc of the wheel assembly of FIG. 7.

FIG. 9 is a perspective view of a cover on the wheel assembly of FIG. 8.

FIG. 10 is a view showing one example of a second attachment interface between the clad disc and the basic disc of the wheel assembly of FIG. 7.

### DETAILED DESCRIPTION OF THE PREFERRED EMBODIMENT

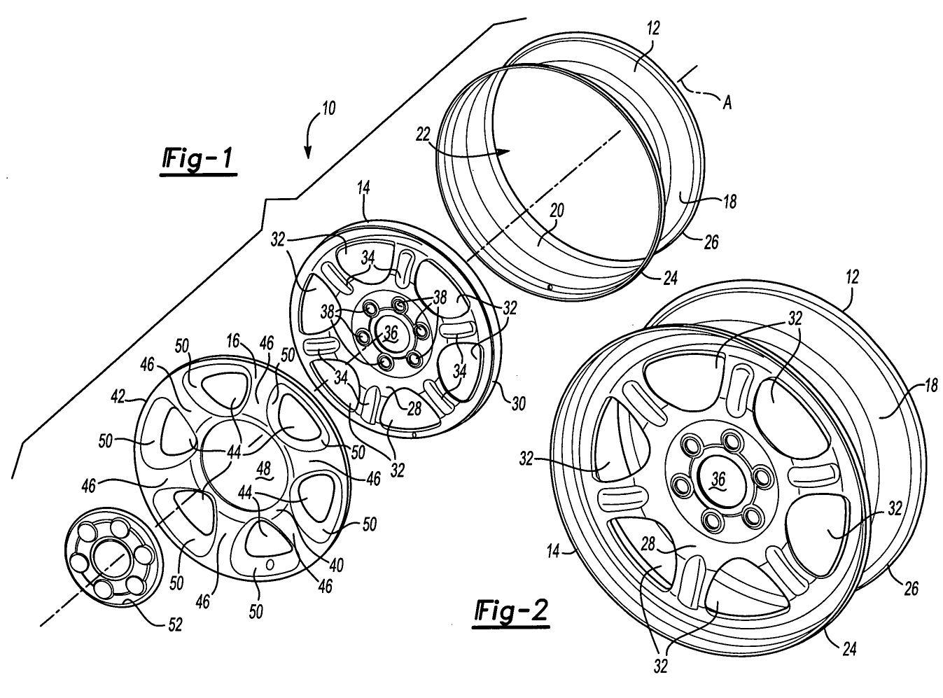

A vehicle wheel assembly 10, as shown in FIG. 1, includes a rim 12, a basic disc 14, and a clad disc 16. The rim 12 includes an outer circumferential surface 18 and an inner circumferential surface 20 that defines an inner wheel cavity 22. First 24 and second 26 rim flanges extend outwardly from the outer circumferential surface 18 at opposing rim edges. A tire (not shown) is sealed against the outer circumferential surface 18 as known.

The basic disc 14 includes a generally vertically extending disc face 28 with disc flange 30 extending transversely relative to the disc face 28. A first plurality of ventilation openings 32 is formed within the disc face 28. The ventilation openings 32 are separated from each other by spokes 34, which also form part of the disc face 28.

The disc face 28 includes a center opening 36 that defines a wheel axis of rotation A. The ventilation openings 32 are circumferentially spaced apart from each other about the center opening 36. A plurality of mounting holes 38 are formed about the center opening 36. The mounting holes 38 receive fasteners (not shown) to attach the vehicle wheel assembly 10 to an associated wheel mount on an axle (not shown) in a bolted joint attachment as known.

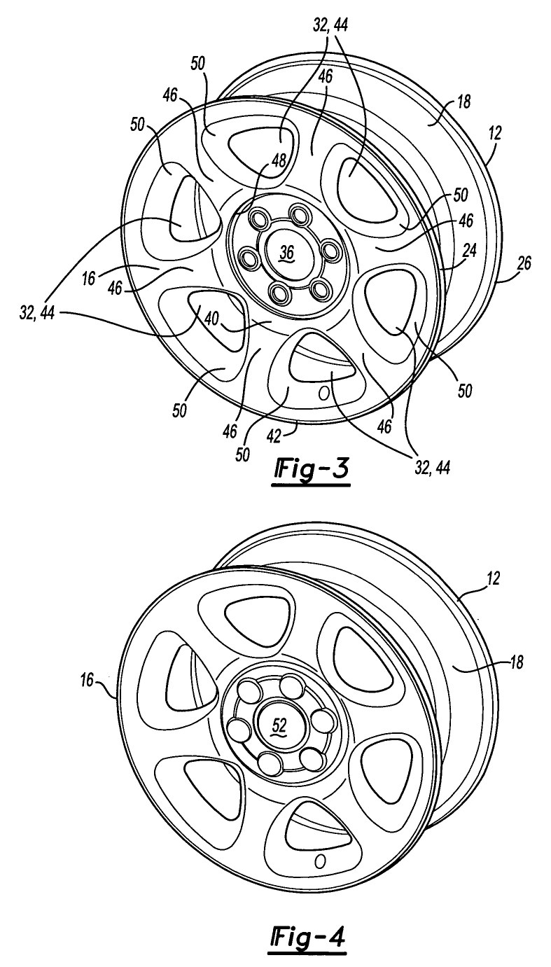

The basic disc 14 is attached to the rim 12 as shown in FIG. 2. The attachment interface between the basic disc 14 and the rim 12 will be discussed in greater detail below. The clad disc 16 is overlaid on top of the basic disc 14 as shown in FIG. 3. The clad disc 16 provides an aesthetically pleasing appearance and can be formed to have many different configurations.

The clad disc 16 includes a generally vertically orientated disc face 40 that extends out to a peripheral edge 42. A second plurality of ventilation openings 44 is formed within the disc face 40. The ventilation openings 44 are separated from each other by spokes 46, which also form part of the disc face 40. The disc face 40 also includes a center opening 48. The ventilation openings 44 are circumferentially spaced apart from each other about the center opening 48.

As shown in FIG. 3, the center opening 48 of the clad disc 16 is aligned with the center opening 36 of the basic disc 14 and the second plurality of ventilation openings 44 is aligned with the first plurality of ventilation openings 32 of the basic disc 14 as the clad disc 16 is overlaid on the basic disc 14. The clad disc 16 is then attached to the basic disc 14. This attachment interface will be discussed in greater detail below.

In the configuration shown in FIGS. 1-4, each of the second plurality of ventilation openings 44 includes a flange portion 50 surrounding a perimeter that defines the ventilation opening 44. The flange portions 50 are aligned with a corresponding ventilation opening 32 of the first plurality of ventilation openings 32. Thus, the flange portions 50 are formed to be generally transverse to the disc face 40.

A cover 52 is then overlaid on top of the clad disc 16 at the center opening 48 as shown in FIG. 4. This covers and hides the bolted joint attachment. The cover 52 protects the bolted joint attachment and additionally improves the aesthetic appearance of the vehicle wheel assembly 10.

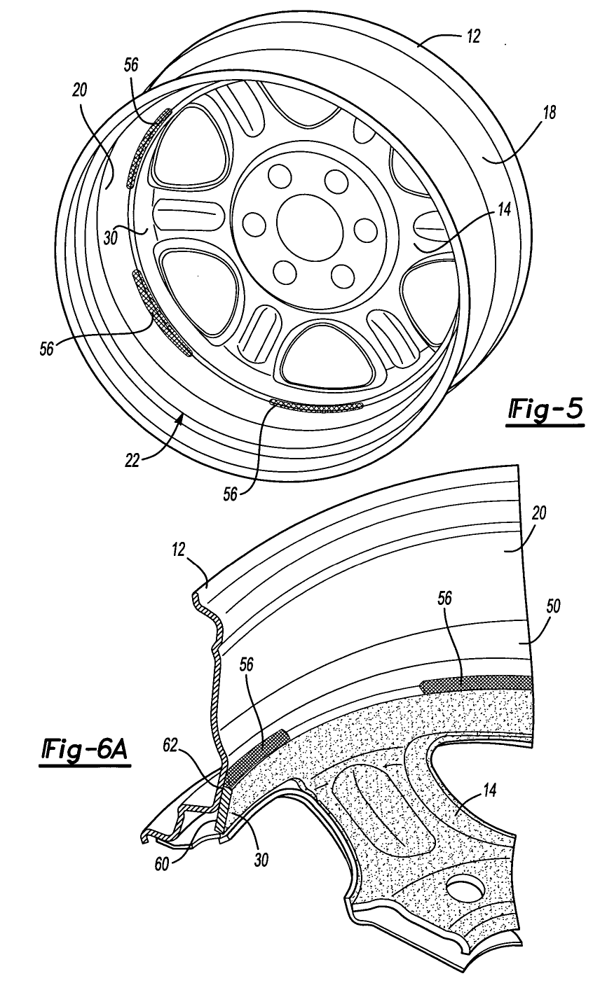

The basic disc 14 and the clad disc 16 are assembled to the rim 12 in the following manner. The disc flange 30 is received within the inner wheel cavity 22 and abuts against the inner circumferential surface 20 in a press fit as shown in FIG. 5. The disc flange 30 is then welded to the rim 12 at the inner circumferential surface 20 to form a first attachment interface between the basic disc 14 and the rim 12. The first attachment interface can comprise a continuous weld about the entire inner circumference of the rim 12. Optionally, the first attachment interface can comprise a plurality of discrete welds 56, spaced apart from each other about the inner circumference.

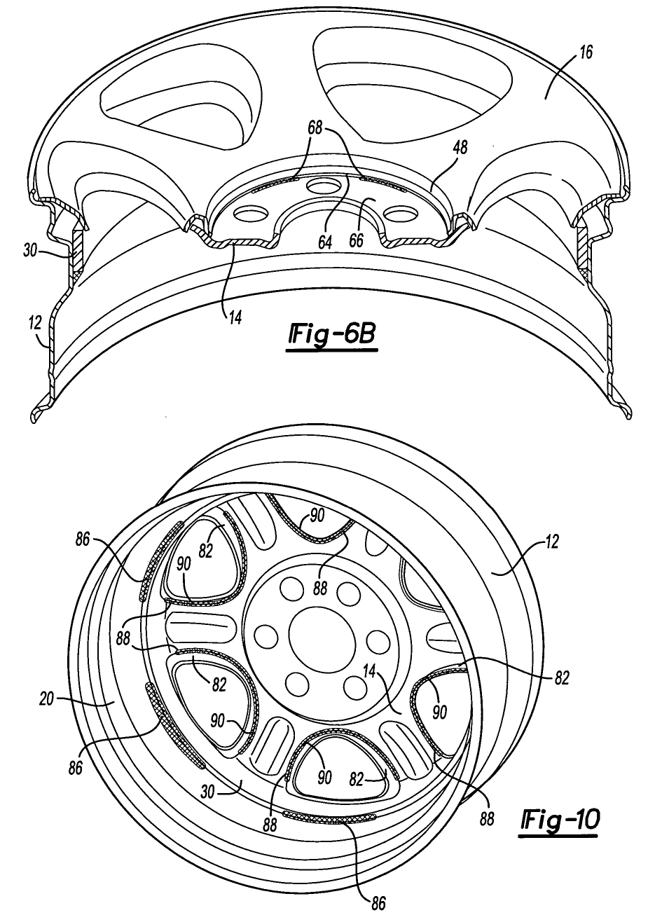

The first attachment interface preferably occurs near a center portion 58 of the inner circumferential surface 20 as shown in FIG. 6A. An outer or external surface 60 of the disc flange 30 directly abuts against the inner circumferential surface 20 and a weld interface 62 is formed at a peripheral edge of the disc flange 30 and the inner circumferential surface 20.

The clad disc 16 is then overlaid on top of the basic disc 14 and the clad disc 16 is welded to the basic disc 14 at a second attachment interface as shown in FIG. 6B. In this example, the second attachment interface is formed between an inner circumferential edge 64 of the center opening 48 of the clad disc 16 and a center portion 66 of the disc face 28 of the basic disc 14. The second attachment interface can be formed as a continuous weld about the entire inner circumferential edge 64 or a plurality of discrete welds 68 can be used.

In this configuration, the first attachment interface is formed at a first radial distance from the wheel axis of rotation A and the second attachment interface is formed at a second radial distance from the wheel axis of rotation A. The second radial distance is less than the first radial distance.

FIG. 7 shows an exploded view of another example of a vehicle wheel assembly 70. This vehicle wheel assembly 70 is similar to that shown in FIG. 1 except that a different clad disc 72 is attached to the basic disc 14. Thus, the vehicle wheel assembly 70 has first attachment interface between the basic disc 14 and the rim 12 similar to that discussed above with regard to FIGS. 1-5.

This clad disc 72 includes a vertically orientated disc face 74 with a plurality of ventilation openings 76 formed about a center opening 78. The ventilation openings 76 are circumferentially space apart form each other about the center opening 78. A plurality of mounting holes 80 are also formed in the disc face 74 and are circumferentially spaced apart from each other about the center opening 78. The mounting holes 80 are at a first radial distance from the wheel axis of rotation A and the ventilation openings 76 are at a second radial distance from the wheel axis of rotation A that is greater than the first radial distance.

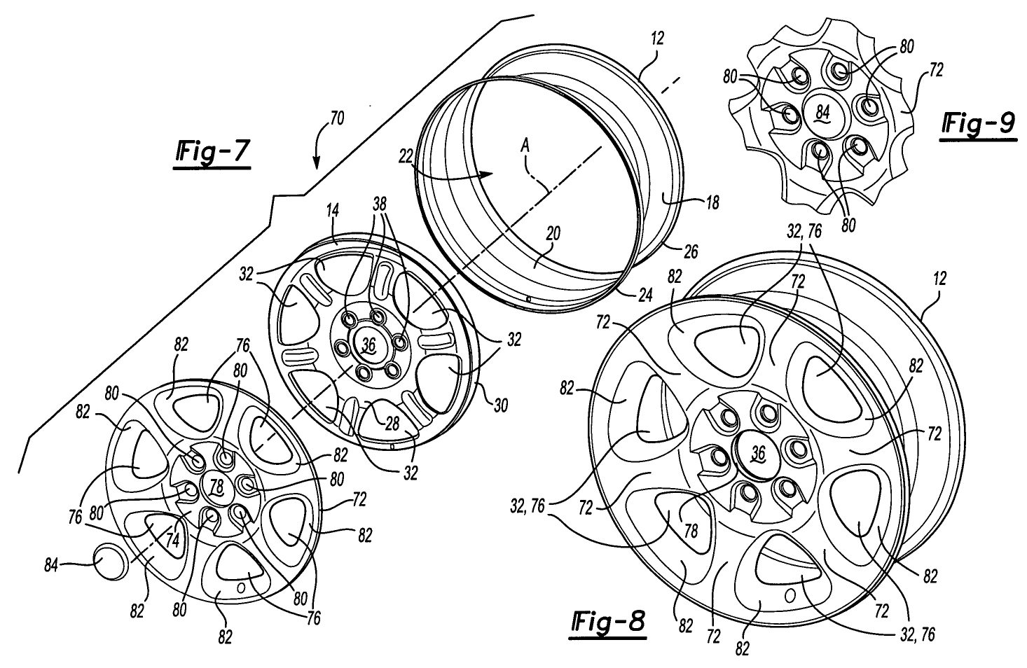

As shown in FIG. 8, the center opening 78 of the clad disc 72 is aligned with the center opening 36 of the basic disc 14 and the ventilation openings 76 are aligned with corresponding ventilation openings 32 of the basic disc 14 as the clad disc 72 is overlaid on the basic disc 14. The mounting holes 80 of the clad disc 72 are also aligned with the mounting holes 38 of the basic disc 14. The clad disc 72 is then attached to the basic disc 14. This attachment interface will be discussed in greater detail below.

In the configuration shown in FIGS. 7-10, each ventilation opening 76 of the clad disc 72 includes a flange portion 82 surrounding a perimeter that defines the ventilation opening 76. The flange portions 82 are aligned with a corresponding ventilation opening 32 of the first plurality of ventilation openings 32 in the basic disc 14. Thus, the flange portions 82 are formed to be generally transverse to the disc face 74.

Fasteners (not shown) are received within mounting holes 38, 80 of the basic disc 14 and clad disc 72, respectively, to form a bolted joint attachment to a wheel mount on an axle (not shown) as known. A cover 84 is then overlaid on top of the clad disc 72 at the center opening 78 as shown in FIG. 9. The cover 84 only covers the center opening 78 and leaves the bolted joint attachment uncovered.

As shown in FIG. 10, the first attachment interface between the basic disc 14 and the rim 12 is comprised of a weld interface 86 between the disc flange 30 and the inner circumferential surface 20 of the rim. The second attachment interface between the clad disc 72 and the basic disc 14 is comprised of a weld interface 88 between the flange portions 82 and perimeter portion 90 that define the ventilation openings 32 in the basic disc 14. Preferably, every flange portion 82 is attached to a corresponding perimeter portion 90 on the basic disc 14. In the example shown, only one side of the flange portion 82 is welded to the perimeter portion 90. However, a continuous weld interface could optionally be formed about the entire perimeter of the ventilation openings 32 if needed.

The rim 12, basic disc 14, and clad disc 16, 72 are preferably formed from steel material as known. However, other known wheel materials could also be used to form the rim 12, basic disc 14, and clad disc 16, 72.

The vehicle wheel assemblies 10, 70 have significant advantages compared to prior wheel designs. The use of a pair of discs, i.e. a basic disc 14 and a clad disc 16, 72, provides a robust wheel structure with more wheel resistance (disc resistance plus clad resistance). Also, by using two discs, the basic disc 14 is not required to have as great a thickness as is required when only a single disc is used. Thus, the use of an additional clad disc allows the basic disc thickness to be reduced, which results in less pressing force being required to stamp the basic disc 14.

Additionally, ventilation openings can be increased in size due to the two disc configuration. This improves cooling for an associated wheel brake assembly. Also the use of an additional clad disc 16, 72 allows for more styling flexibility and provides an aesthetically pleasing appearance. If necessary, the edge of the clad disc 16, 72 can be machined in order to further improve appearance if the edge is exposed.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A vehicle wheel assembly comprising:
a first wheel component having an inner circumferential surface and an outer circumferential surface;
a second wheel component attached to said inner circumferential surface at a first attachment interface; and
a third wheel component attached to said second wheel component at a second attachment interface independent from said first attachment interface.

2. The vehicle wheel assembly according to claim 1 wherein said first and second attachment interfaces are weld interfaces.

3. The vehicle wheel assembly according to claim 1 wherein said first attachment interface comprises a first plurality of discrete welds circumferentially spaced apart from each other about a wheel axis of rotation at a first radial distance.

4. The vehicle wheel assembly according to claim 3 wherein said second attachment interface comprises a second plurality of discrete welds circumferentially spaced apart from each other about the wheel axis of rotation at a second radial distance that is less than the first radial distance.

5. The vehicle wheel assembly according to claim 1 wherein said first wheel component comprises a rim having first and second rim flanges at opposing rim edges, said outer circumferential surface extending between said first and second rim flanges and wherein said second wheel component comprises a first disc having a first vertically extending surface and a transversely extending flange portion formed about a perimeter of said first disc wherein an external surface of said transversely extending flange portion is in abutting engagement with said inner circumferential surface of said rim.

6. The vehicle wheel assembly according to claim 5 wherein said third wheel component comprises a second disc that is overlaid on top of said first disc.

7. The vehicle wheel assembly according to claim 6 wherein said first disc includes a first plurality of ventilation openings formed within said first vertically extending surface and circumferentially spaced about a wheel axis of rotation and wherein said second disc includes a second vertically extending surface and a second plurality of ventilation openings circumferentially spaced about the wheel axis of rotation, each of said second plurality of ventilation openings including a flanged portion that is aligned with a corresponding one of said first plurality of ventilation openings.

8. The vehicle wheel assembly according to claim 7 wherein said first attachment interface comprises a weld interface between said transversely extending flange portion of said first disc and said inner circumferential surface of said rim, and said second attachment interface comprises a weld interface between a circumferential edge of each of said flanged portions of said second plurality of ventilation openings and said first disc.

9. The vehicle wheel assembly according to claim 7 wherein said second disc includes a center opening formed about the wheel axis of rotation and wherein said first attachment interface comprises a weld interface between said transversely extending flange portion of said first disc and said inner circumferential surface of said rim, and said second attachment interface comprises a weld interface between a circumferential edge of said center opening of said second disc and said first disc.

10. A vehicle wheel assembly comprising:
a rim having an inner circumferential surface and an outer circumferential surface and including first and second rim flanges extending outwardly from said outer circumferential surface at opposing rim edges, said inner circumferential surface defining an inner wheel cavity;
a first wheel disc having a first vertically extending surface and a transversely extending flange portion formed about a perimeter of said first wheel disc wherein said transversely extending flange portion is received within said inner wheel cavity;
a second wheel disc having a second vertically extending surface with a center opening formed about a wheel axis of rotation; and
wherein said transversely extending flange portion of said first wheel disc is attached to said inner circumferential surface of said rim at a first attachment interface and said second wheel disc is attached to said first wheel disc at a second attachment interface independent from said first attachment interface.

11. The vehicle wheel assembly according to claim 10 wherein said first attachment interface comprises a first weld interface and said second attachment interface comprises a second weld interface.

12. The vehicle wheel assembly according to claim 11 wherein said second weld interface is formed between a peripheral edge of said center opening and said first vertically extending surface of said first wheel disc.

13. The vehicle wheel assembly according to claim 11 wherein said second wheel disc includes a plurality of ventilation openings circumferentially spaced about said center opening with said second weld interface being formed between a peripheral edge of at least one of said plurality of ventilation openings and said first vertically extending surface of said first wheel disc.

14. The vehicle wheel assembly according to claim 11 wherein said first and said second weld interfaces are each comprised of a plurality of discrete welds circumferentially spaced about the wheel axis of rotation.

15. The vehicle wheel assembly according to claim 11 wherein said first wheel disc includes a first plurality of ventilation openings formed within said first vertically extending surface and said second wheel disc includes a second plurality of ventilation openings formed within said second vertically extending surface and wherein each ventilation opening of said second plurality of ventilation openings includes a transversely extending peripheral flange that is aligned with a corresponding one of said first plurality of ventilation openings when said first wheel disc is attached to said second wheel disc.

16. A method of assembling a vehicle wheel assembly comprising:
(a) welding a first wheel disc to an inner circumferential surface of a rim at a first attachment interface;
(b) overlaying a second wheel disc on top of the first wheel disc; and
(c) welding the second wheel disc to the first wheel disc at a second attachment interface.

17. The method according to claim 16 wherein step (a) includes forming the first wheel disc with a first vertically extending surface and a transverse flange portion extending about a perimeter of the first vertically extending surface, abutting an exterior surface of the transverse flange portion against the inner circumferential surface, and welding the transverse flange portion to the inner circumferential surface.

18. The method according to claim 17 including providing the first wheel disc with a first center opening formed about a wheel axis of rotation and a first plurality of ventilation openings formed within the first vertically extending surface and circumferentially spaced relative to the first center opening;
providing the second wheel disc with a second vertically extending surface, and with a second center opening formed about the wheel axis of rotation and including a second plurality of openings formed within the second vertically extending surface and circumferentially spaced relative to the second center opening; and
wherein step (b) includes aligning each of the second plurality of ventilation openings with a corresponding one of the first plurality of ventilation openings.

19. The method according to claim 18 wherein step (c) includes welding at least a portion of a peripheral edge of the second center opening to a center portion of the first wheel disc.

20. The method according to claim 18 wherein step (c) includes welding at least a portion of a peripheral edge of at least one of the second plurality of ventilation openings to the first vertically extending surface of the first wheel disc at a corresponding peripheral edge of a corresponding one of the first plurality of ventilation openings.
